(19) United States
(12) Patent Application Publication
(10) Pub. No.: US 2006/0114087 A1
(43) Pub. Date: Jun. 1, 2006

(54) Magnetic plug for power cable

(76) Inventor: Jin-Yuan Deng, Taichung (TW)

Correspondence Address: NIKOLAI & MERSEREAU, P.A., 900 SECOND AVENUE SOUTH, SUITE 820, MINNEAPOLIS, MN, 55402, US

(21) Appl. No.: 10/998,249

(22) Filed: Nov. 29, 2004

(51) Int. Cl. H01H 9/00

(52) U.S. Cl. 335/205

(57) ABSTRACT

The present invention relates to a magnetic plug for power cable, in the magnetic plug is provided with a grounding leaf spring which is located opposite a receptacle, when the magnetic plug is connected to the receptacle through permanent magnet, the grounding leaf spring elastic force is smaller than a contact force between the magnetic plug and the receptacle, when a force greater than a predetermined value is applied to the power cable, this force will cooperate with the elastic force of the leaf spring instantly to disconnect the magnetic plug from the receptacle.

### BACKGROUND OF THE INVENTION

1. Field of the Invention

The present invention relates to an electric component, and more particularly to a magnetic plug for power cable.

2. Description of the Prior Arts

Referring to FIGS. 1-3, a magnetic plug and a receptacle for small electrical appliance (such as small type water dispenser, electric thermos, and etc) are shown. The magnetic plug includes a magnetic plug 10 having an extended end 100 and a connecting end 101. The connecting end 101 is provided with a positive and a negative terminal that can be connected to the positive and the negative terminal of the receptacle 11 through permanent magnets.

Normally, the magnetic plug and the receptacle 11 are not provided with any static grounding but an independent earth wire 13, but the problem is that the user has difficulty in finding a receptacle to insert this earth wire 13. Furthermore, the small type electric appliance 12 is much smaller and lighter than the big electric appliance, such as the refrigerator, the washing machine, and etc, and the magnetic plug 10 is designed to make it easy to disconnect the power cable when needed, so as to enable the small electric appliance 12 to be moved or cleaned freely without the limitation of power cable. In order to improve the safety, the connection between the magnetic plug 10 and the receptacle 11 is designed so that the magnetic plug 10 can be disconnected from the receptacle 11 very easily when a certain force is applied, thus preventing the electric appliance 12 from being knocked over. To achieve this effect, as shown in the figures, the extended end 100 is folded at an angle to the magnetic plug 10, and the magnetic plug 10 is slantingly inserted in the receptacle 11. However, none of the conventional magnetic plugs is combined with static grounding.

The present invention has arisen to mitigate and/or obviate the afore-described disadvantages.

### SUMMARY OF THE INVENTION

The primary objective of the present invention is to provide a magnetic plug for power cable, in the magnetic plug is provided with a grounding leaf spring which is located opposite a receptacle, when the magnetic plug is connected to the receptacle through permanent magnet, the grounding leaf spring elastic force is smaller than a contact force between the magnetic plug and the receptacle, when a force greater than a predetermined value is applied to the power cable, this force will cooperate with the elastic force of the leaf spring instantly to disconnect the magnetic plug from the receptacle.

The present invention will become more obvious from the following description when taken in connection with the accompanying drawings, which show, for purpose of illustrations only, the preferred embodiments in accordance with the present invention.

### BRIEF DESCRIPTION OF THE DRAWINGS

FIG. 1 is an operational view of a conventional magnetic plug;

FIG. 2 is an operational view in accordance with an embodiment of a conventional magnetic plug;

FIG. 3 is an operational view in accordance with another embodiment of a conventional magnetic plug;

FIG. 4 is an exploded view of a magnetic plug in accordance with the present invention;

FIG. 5 is an illustrative view of showing the magnetic plug in accordance with the present invention being engaged in the receptacle;

FIG. 6 is an illustrative view of showing the magnetic plug in accordance with the present invention being disengaged from the receptacle;

FIG. 7 is an exploded view of a magnetic plug derived from the present invention.

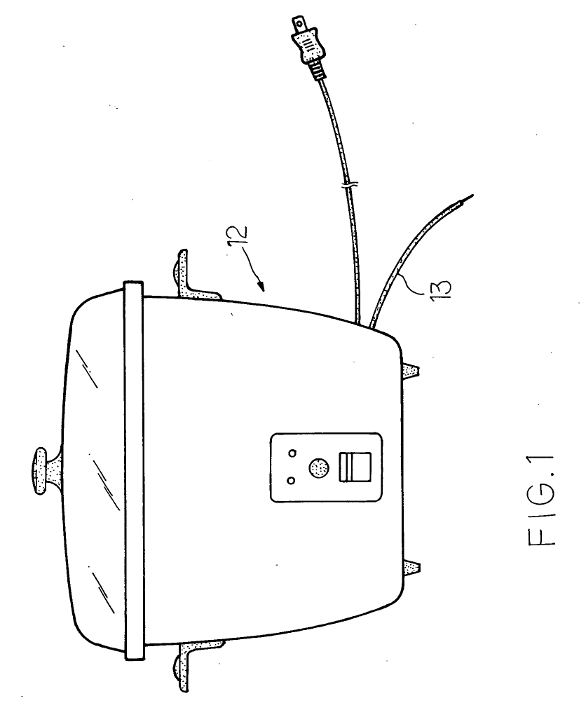

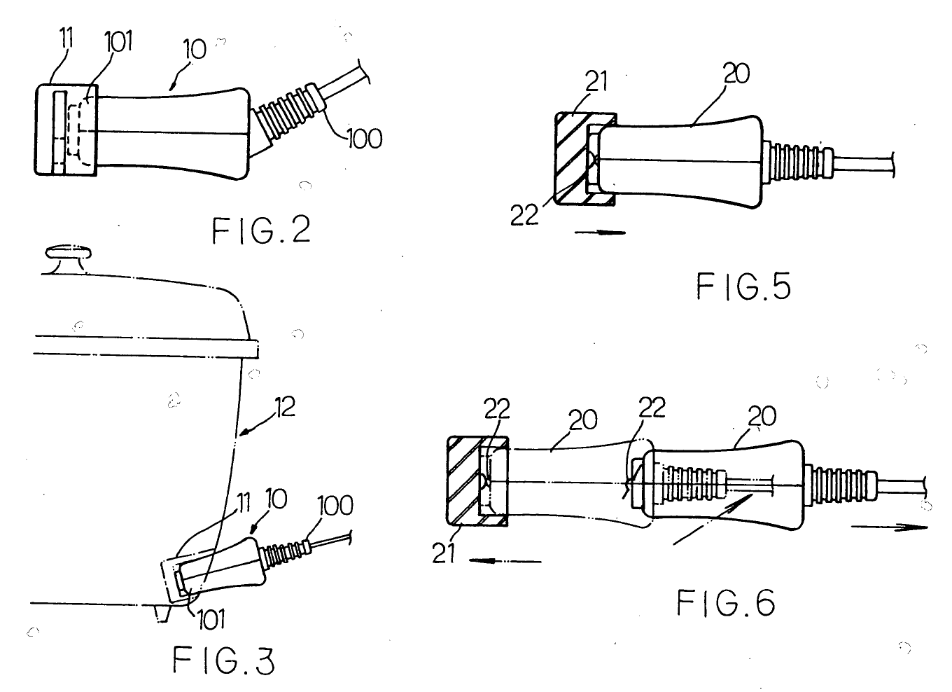

### DETAILED DESCRIPTION OF THE PREFERRED EMBODIMENTS

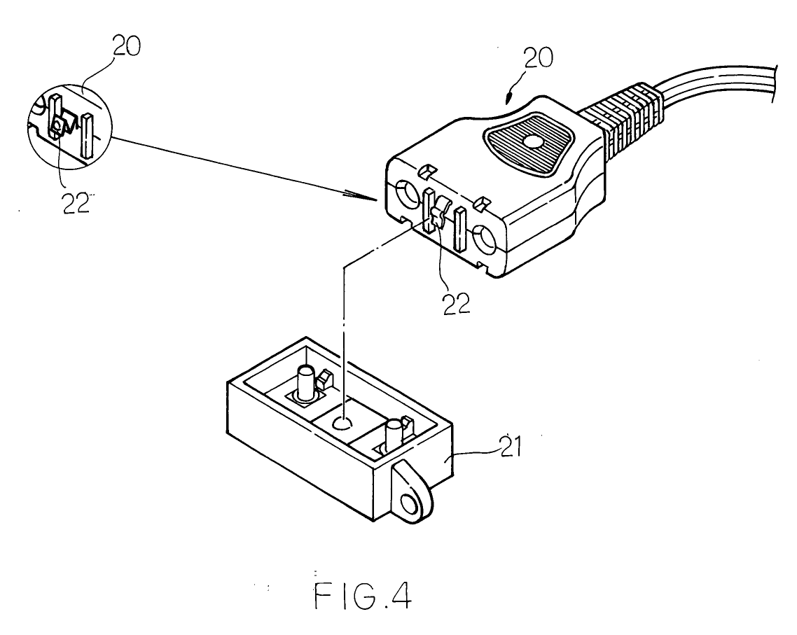

Referring to FIGS. 4-6, a magnetic plug 20 for power cable in accordance with the present invention is provided with an earth wire which is to be connected to the earth terminal (not shown) inside the receptacle 21, and the earth wire of the magnetic plug 20 is made into a leaf spring 22 located opposite the receptacle 21. When the magnetic plug 20 is magnetically connected to the receptacle 21, the leaf spring 22 will be compressed between the magnetic plug 20 and the receptacle 21. The elastic force of the leaf spring 22 is a slightly smaller than the contact force between the magnetic plug 20 and the receptacle 21, so that the magnetic plug 20 will disconnect from the receptacle 21 when a certain force is applied.

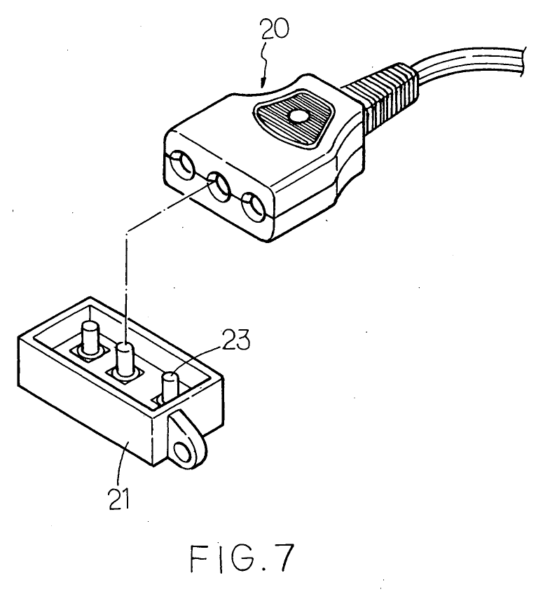

Referring further to FIG. 7, if the “easy-disconnection” is not considered as necessary, the magnetic plug 20 can be designed to have three sockets (represent the positive pole, the negative pole and the grounding) for mating with the three terminals 23 of the receptacle 21.

The magnetic plug 20 in accordance with the present invention can provide two functions which are explained as follows:

First, when the magnetic plug 20 is connected to the receptacle 21 through permanent magnet, the grounding leaf spring 22 is under pressure, so that the earth wire (the grounding leaf spring 22) can contact the mating terminal in the receptacle 21 more firmly.

Second, when the magnetic plug 20 is connected to the receptacle 21 through permanent magnet, the grounding leaf spring 22 is under pressure and its elastic force is slightly minor than the critical contact force between the magnetic plug 20 and the receptacle 21. In this case, when a force greater than a predetermined value is applied to the power cable, this force will cooperate with the elastic force of the leaf spring 22 instantly to disconnect the magnetic plug 20 from the receptacle 21. Thus improving the safety of the magnetic plug 20.

While we have shown and described various embodiments in accordance with the present invention, it should be clear to those skilled in the art that further embodiments may be made without departing from the scope of the present invention.

What is claimed is:

1. A magnetic plug for power cable comprising a grounding leaf spring located opposite a receptacle, when the magnetic plug is connected to the receptacle through permanent magnet, the grounding leaf spring elastic force is smaller than a contact force between the magnetic plug and the receptacle, when a force greater than a predetermined value is applied to the power cable, this force will cooperate with the elastic force of the leaf spring instantly to disconnect the magnetic plug from the receptacle.
